(19) United States
(12) Patent Application Publication
(10) Pub. No.: US 2023/0074216 A1
(43) Pub. Date: Mar. 9, 2023

(54) SYSTEM AND METHOD FOR PRESERVING ACCESS CONTROL LISTS IN STORAGE DEVICES

(71) Applicant: EMC IP Holding Company LLC, Hopkinton, MA (US)

(72) Inventors: Prachi Sharma, Haridwar (IN); Adrian Dobrean, Ontario (CA); Vibhanshu Rai, Azamgarh (IN)

(21) Appl. No.: 17/469,000

(22) Filed: Sep. 8, 2021

(51) Int. Cl. G06F 11/14; G06F 16/11

(52) U.S. Cl. CPC G06F 11/1451; G06F 16/128; G06F 2201/80; G06F 2201/82

(57) ABSTRACT

A method for preserving data stored in a source device is provided. The method includes: obtaining a first snapshot of the data; retrieving, based on the first snapshot, access control information associated with the data; storing, in response to the retrieving and in an access control device separate from the source device, the access control information as an access control file; copying, after the storing and using the first snapshot, the data to a target device to obtain a backup of the data in the target device; and transmitting, after the copying, the access control file to the target device and storing the access control file with the backup.

### BACKGROUND

Data stored in a storage device may often be accompanied by information regarding entities that do or do not have permission to access the data, such as, for example, one or more access control lists (ACLs). These ACLs allow owners of the data to set different permissions for specific named users or named group to access the data. Preservation of these ACLs during a backup or a restoration of the data is an arduous process that consumes large amounts of computing resources, and in many cases is not even possible. However, users may still wish to have a way to preserve these ACLs during data backup and restoration.

### SUMMARY

In general, certain embodiments described herein relate to a method for preserving data stored in a source device. The method comprises: obtaining a first snapshot of the data; retrieving, based on the first snapshot, access control information associated with the data; storing, in response to the retrieving and in an access control device separate from the source device, the access control information as an access control file; copying, in response to the storing and using the first snapshot, the data to a target device to generate a backup of the data in the target device; and transmitting, in response to the copying, the access control file to the target device and storing the access control file with the backup.

In general, certain embodiments described herein relate to a non-transitory computer readable medium (CRM) comprising computer readable program code, which when executed by a computer processor enables the computer processor to perform a method for processing trust and security for leased infrastructure. The method comprises: obtaining a first snapshot of the data; retrieving, based on the first snapshot, access control information associated with the data; storing, in response to the retrieving and in an access control device separate from the source device, the access control information as an access control file; and copying, in response to the storing and using the first snapshot, the data to a target device to generate a backup of the data in the target device. In response to the copying, the access control file is transmitted by the access control device to the target device and stored with the backup.

In general, certain embodiments described herein relate to a source device including: a storage storing data; and a processor coupled to the storage. The processor is configured to: obtain a first snapshot of the data; retrieve, based on the first snapshot, access control information associated with the data; store, in response to the retrieving and in an access control device separate from the source device, the access control information as an access control file; and copy, in response to the storing and using the first snapshot, the data to a target device to generate a backup of the data in the target device. In response to the copying, the access control file is transmitted by the access control device to the target device and stored with the backup.

Other aspects of the embodiments disclosed herein will be apparent from the following description and the appended claims.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1.1 shows a system in accordance with one or more embodiments.

FIG. 1.2 shows a diagram of an example source device in accordance with one or more embodiments.

FIG. 1.3 shows a diagram of an example access control device in accordance with one or more embodiments.

FIG. 1.4 shows a diagram of an example target device in accordance with one or more embodiments.

FIG. 2.1 shows a flowchart of a process for preserving data during a full backup of a source device in accordance with one or more embodiments.

FIG. 2.2 shows a flowchart of a process for preserving data during an incremental backup of the source device in accordance with one or more embodiments.

FIG. 2.3 shows a flowchart of a process for restoring data to the source device in accordance with one or more embodiments.

FIGS. 3.1-3.5 show an implementation example in accordance to one or more embodiments.

FIG. 4 shows a computer system in accordance to one or more embodiments.

### DETAILED DESCRIPTION

Specific embodiments will now be described with reference to the accompanying figures.

In the below description, numerous details are set forth as examples of embodiments described herein. It will be understood by those skilled in the art, that have the benefit of this Detailed Description, that one or more embodiments described herein may be practiced without these specific details and that numerous variations or modifications may be possible without departing from the scope of the embodiments described herein. Certain details known to those of ordinary skill in the art may be omitted to avoid obscuring the description.

In the below description of the figures, any component described with regard to a figure, in various embodiments described herein, may be equivalent to one or more like-named components described with regard to any other figure. For brevity, descriptions of these components may not be repeated with regard to each figure. Thus, each and every embodiment of the components of each figure is incorporated by reference and assumed to be optionally present within every other figure having one or more like-named components.

Additionally, in accordance with various embodiments described herein, any description of the components of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct connection (e.g., wired directly between two devices or components) or indirect connection (e.g., wired and/or wireless connections between any number of devices or components connecting the operatively connected devices). Thus, any path through which information may travel may be considered an operative connection.

One or more embodiments disclosed herein are directed to systems and methods for preserving data stored in a source device. In particular, in one or more embodiments, an access control file for storing ACL associated information (herein referred to as “access control information”) may be configured in a device (herein referred to as an “access control device”) separate from a source device storing data to be backed up. In one or more embodiments, once the source device completes backing up the data to a target device, the access control device transmits the access control file to the target device to be stored with the backed up data. This may advantageously reduce the amount of computing resources required to keep the access control information together with the data being backed up during the backup process, which improves the computer functionalities of a device (e.g., the source device storing the data) performing the backup. Said another way, the ACL database (e.g., the access control file) may be stored separately, while still being associated with the backup of the data in the target device.

The various embodiments discussed above are now described in more detail below.

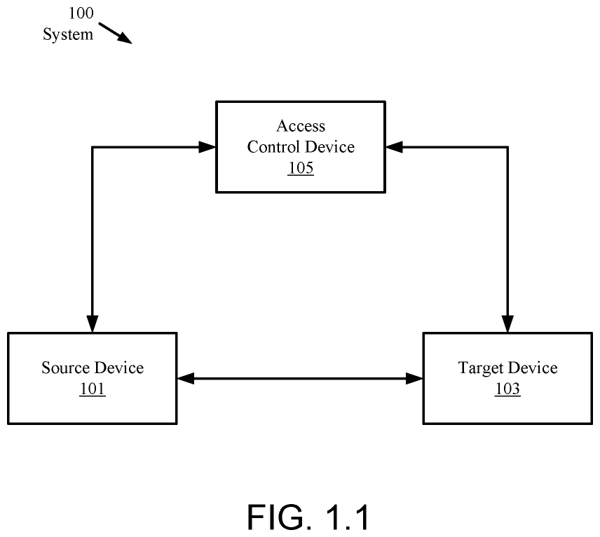

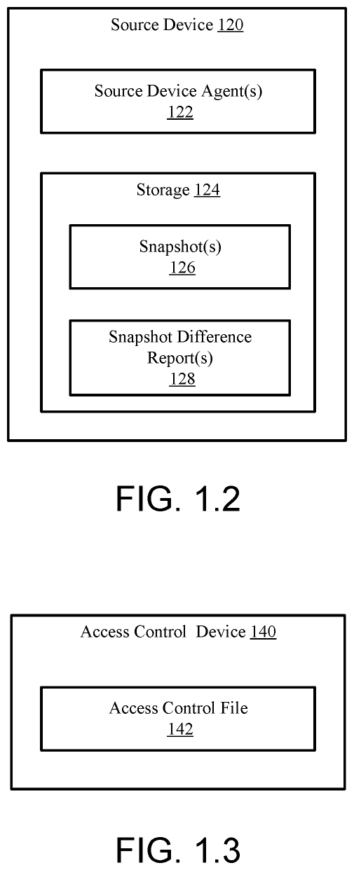

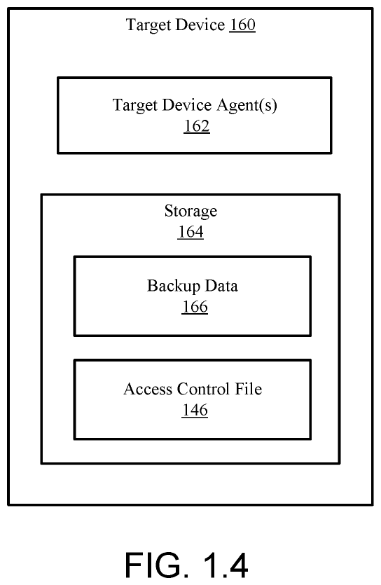

FIG. 1.1 shows a system (100) in accordance with one or more embodiments. The system (100) includes a source device (101), a target device (103), and an access control device (105). Each of these components of the system will be described in more detail below.

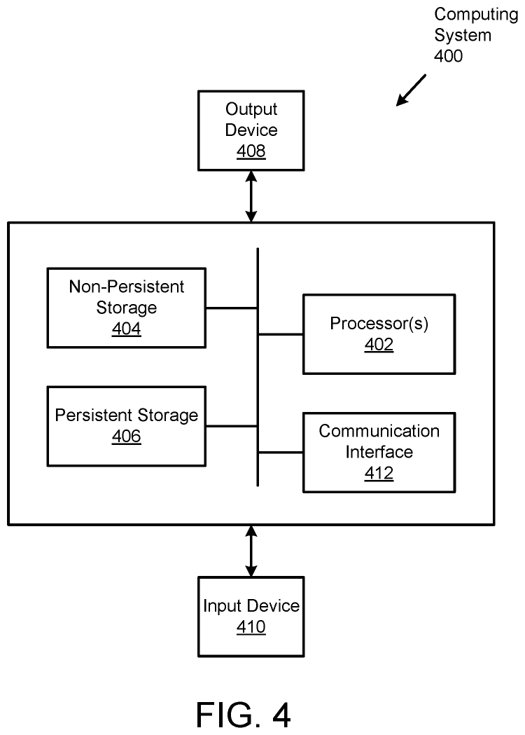

In one or more embodiments disclosed herein, the source device (101) may be physical device (e.g., a computing device with at least one or more processor(s), memory, and an operating system such as the computing system 400 of FIG. 4) or a virtual device (e.g., a virtual machine executing on one or more physical devices) configure to store data.

More specifically, in one or more embodiments, the source device (101) may be any device being used as a source for data that is to be backed up to another device (e.g., the target device (103)). Examples of the source device (101) may include, but are not limited to, a data storage server, a file system (e.g., a Hadoop Distributed File System), etc. The source device (101) may be directly (or operatively, e.g., via a network (not shown)) connected to the target device (103) and the access control device (105).

In one or more embodiments disclosed herein, the target device (103) may be a physical device or a virtual device (as discussed above) configured to store backup data (e.g., a backup of the data stored in the source device (101) (also referred to herein as a “backup”). More specifically, the target device (103) may be any device being used as a storage target during a data backup process. The target device (103) may be directly (or operatively, e.g., via the network) connected to the source device (101) and the access control device (105).

In one or more embodiments disclosed herein, the access control device (105) may be a physical device or a virtual device (as discussed above) such as a personal (or business-use) computing system (e.g., a laptop, a cell phone, a tablet computer, a virtual machine executing on a server, etc.) of a user (i.e., an owner of the data stored in the source device). The access control device (105) may be directly (or operatively, e.g., via the network) connected to the source device (101) and the target device (103).

Additional details of each of the source device (101), the target device (103), and the access control device (105) are discussed below in FIGS. 1.2-1.4, respectively.

Turning now to FIG. 1.2, FIG. 1.2 shows an example source device (120) in accordance with one or more embodiments of this disclosure. The source device (120) may be the same as the source device (101) described above in FIG. 1.1. In addition to the components discussed above in reference to FIG. 1.1, the source device (120) further includes: one or more source device agents (122); and a storage (124) storing one or more snapshots (126) and snapshot difference reports (128). Each of the components illustrated in FIG. 1.2 is described below.

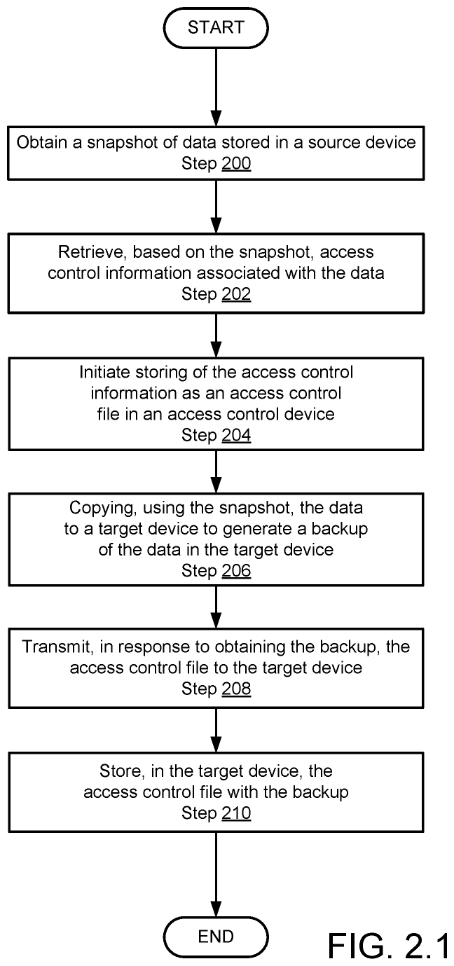

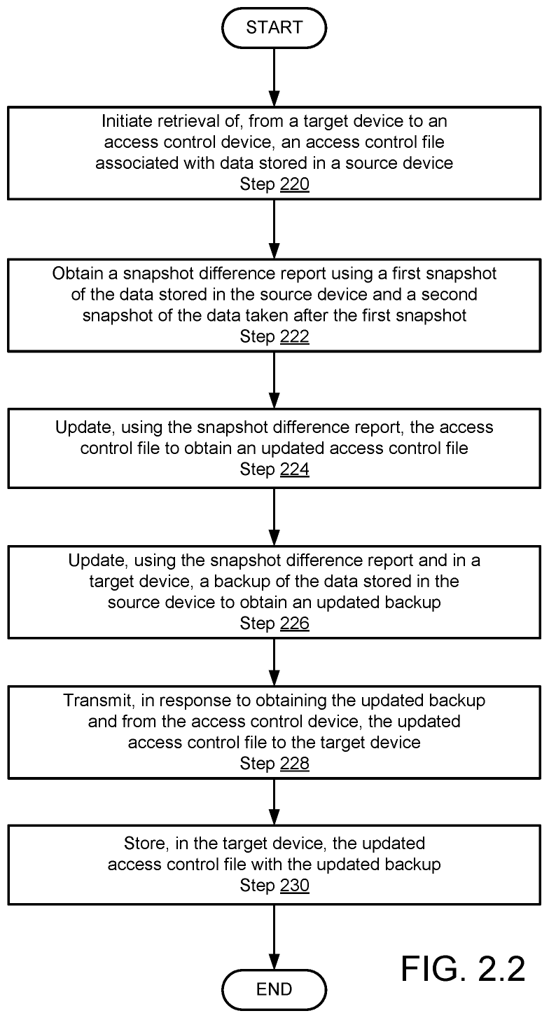

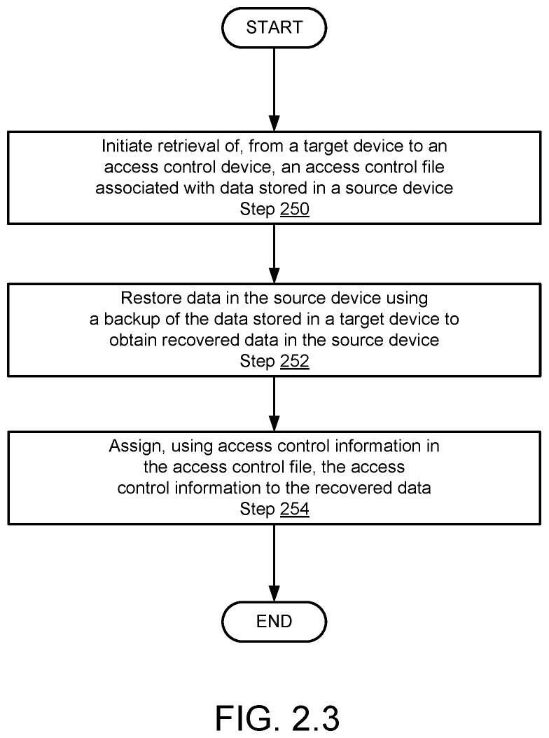

In one or more embodiments disclosed herein, the source device agent(s) (122) may be configured in hardware (e.g., circuitry), software, or any combination thereof. The source device agent(s) (122) interacts with the other components of the source device (120) to facilitate the implementation of one or more protocols, services, and/or features of the network device. For example, the source device agent(s) (122) may be used for performing one or more steps of processes in accordance with various embodiments of the disclosure (e.g., the processes discussed below in FIGS. 2.1-2.3). By way of example, the source device agent(s) (122) may be one or more application programming interfaces (APIs) executing on the source device (120). More specifically, the source device agent(s) (122) may be one or more APIs associated with a distributed copy (DISTCP) tool for larger inter/intra-cluster copying.

In one or more embodiments disclosed herein, the storage (124) is implemented using devices that provide data storage services (e.g., storing data and providing copies of previously stored data). For example, storage (124) may include any quantity and/or combination of memory devices (i.e., volatile storage), longer term storage devices (i.e., persistent storage), other types of hardware devices that may provide short term and/or long term data storage services, and/or logical storage devices (e.g., virtual persistent storage/virtual volatile storage).

In one or more embodiments, the storage (124) may store data (not shown) including, as an example, one or more files. The files making up the data may be stored (i.e., organized) in one or more directories (e.g., folders) and/or sub-directories. Each of the files may be associated with one or more access control information items reflecting permission information for access to each of the files. Such access control information may relate to individual files, groups of files, folders, groups of folders, or any other combination of data sharing a common access control scheme. Additionally, in one or more embodiments, the storage may also store one or more snapshots (126) and one or more snapshot difference reports (128), each of which is described in more detail below.

In one or more embodiments disclosed herein, a snapshot (126) includes information capturing a state of the data in the storage (124) at a point in time. The snapshot (126) of the data in the storage (124) may be used to provide, at least in part, recovery of all or any portion of the data in the event that the data is corrupted or lost. For example, the information included in a snapshot (126) may be a detailed table of contents that provides an owner of the data with accessible copies of data that can be used to recover and/or restore the data back to the point at which the snapshot (126) was taken. In one or more embodiments, the snapshot (126) may include a copy of all or any portion of the data (as well as all of the access control information associated with the data) stored within the storage (124) at the point which the snapshot (126) was taken.

In one or more embodiments disclosed herein, a snapshot difference report (128) includes information with regard to a change in the data stored in the storage (124). The snapshot difference report (128) may be generated using two snapshots (126) taken at two different times to reflect a change in the data stored in the storage (124) during a time between the two snapshots (126). For example, assume that a first snapshot A was taken on a Monday. Further assume that a second snapshot B was taken subsequently on a Wednesday (i.e., approximately 48 hours after snapshot A was taken). A snapshot difference report (128) generated using snapshot A and snapshot B will include information with regard to all of the changes to the data that occurred within the 48 hours between the capturing of snapshot A and snapshot B.

In one or more embodiments, information included in the snapshot difference report (128) may include information directed to operations including, but are not limited to: (i) a creation of new files and/or directories that are added to the data stored in the storage (124); (ii) a deletion of files and/or directories making up the data stored in the storage (124); (iii) a renaming of files and/or directories making up the data stored in the storage (124); and (iv) a modification of a content of the files and/or directories making up the data stored in the storage (124).

Turning now to FIG. 1.3, FIG. 1.3 shows an example access control device (140) in accordance with one or more embodiments of this disclosure. The access control device (140) may be the same as the access control device (105) described above in FIG. 1.1. In addition to the components discussed above in reference to FIG. 1.1, the access control device (140) further includes: an access control file (142), which is described in more detail below.

In one or more embodiments disclosed herein, the access control file (142) may be stored in any format (e.g., a database, a data structure, etc.), and may store a portion or all of the access information associated with the data stored in the storage (124) of the source device 120 as described in FIG. 1.2. By way of example, the access control file may be a SQLite database.

In one or more embodiments, the access control information is stored in the access control file as a key-value pair. A key of the key-value pair is a path of the data (namely, one or more files making up the data) in the source device (120). The path of the data may be any type or form of information that would enable a computing device to locate the data within the storage (124). A value of the key-value pair is the access control information associated with the data. For example, assume that the data stored in the source device (120) includes a first file (“File A”) associated with a first access control information (“access control information A”). The access control file will include a key-value pair entry for File A where the key is a path of File A in the storage (124) of the source device and the value is the access control information A.

Turning now to FIG. 1.4, FIG. 1.4 shows an example target device (160) in accordance with one or more embodiments of this disclosure. The target device (160) may be the same as the target device (103) described above in FIG. 1.1. In addition to the components discussed above in reference to FIG. 1.1, the target device (160) further includes: one or more target device agent(s) (162); and a storage (164) storing at least one of a backup data (166) and an access control file (146). Each of the components illustrated in FIG. 1.4 is described below.

In one or more embodiments disclosed herein, the target device agent(s) (162) may be configured in hardware (e.g., circuitry), software, or any combination thereof. The target device agent(s) (162) interacts with the other components of the target device (160) to facilitate the implementation of one or more protocols, services, and/or features of the target device. For example, the target device agent(s) (162) may be used for performing one or more steps of processes in accordance with various embodiments of the disclosure (e.g., the processes discussed below in FIGS. 2.2-2.3). By way of example, the target device agent(s) (162) may be one or more application programming interfaces (APIs) executing on the target device (160). More specifically, the target device agent(s) (162) may be a data-domain-boost (DDBoost) API developed by Dell EMC™ of Austin, Tex. Dell Technologies, Dell, Dell EMC, and other trademarks are trademarks of Dell Inc. or its subsidiaries.

In one or more embodiments disclosed herein, the storage (164) is implemented using devices that provide data storage services (e.g., storing data and providing copies of previously stored data). For example, storage (164) may include any quantity and/or combination of memory devices (i.e., volatile storage), longer term storage devices (i.e., persistent storage), other types of hardware devices that may provide short term and/or long term data storage services, and/or logical storage devices (e.g., virtual persistent storage/virtual volatile storage).

In one or more embodiments disclosed herein, the storage (164) of the target device (160) is configured to store the access control file (146) discussed above in reference to FIG. 1.3 and a backup data (166). In one or more embodiments, the backup data (166) may be a full synthetic backup (i.e., a complete backup copy) of a portion or all of the data stored in the storage (124) of the source device (120). The backup data (166) may be used to restore and/or recover the data in the source device (120) in the event that the data in the source device (120) becomes corrupted or lost (e.g., accidentally deleted by the owner, partially or fully deleted through hacking by a third party, etc.).

In one or more embodiments, multiple ones of the backup data (166) and the access control file (146) may be stored in the storage (164) of the target device (160). Each of the backup data (166) stored in the target device (160) may be associated with at least one of the access control files (146).

One skilled in the art will recognize that the architecture of the system (100), the source device (120), the access control device (140), and the target device (160) is not limited to the components shown in FIGS. 1.1 to 1.4, respectively. For example, the system (100) may include any number of the target devices (103). Further, the source device (120), the access control device (140), and the target device (160) may include components (e.g., a processor) not shown in FIGS. 1.2 to 1.4, respectively. Accordingly, embodiments disclosed herein should not be limited to the devices and/or components shown in FIGS. 1.1-1.4.

FIG. 2.1 shows a flowchart of a method in accordance with one or more embodiments of the invention. The method depicted in FIG. 2.1 may be performed to preserve data during a full backup of a source device in accordance with one or more embodiments of the invention. The method shown in FIG. 2.1 may be performed by, for example, a combination of the source device (e.g., 101, FIG. 1.1; 120, FIG. 1.2), the access control device (e.g., 105, FIG. 1.1; 140, FIG. 1.3), and the target device (e.g., 103, FIG. 1.1; 160, FIG. 1.4).

While FIG. 2.1 is illustrated as a series of steps, any of the steps may be omitted, performed in a different order, additional steps may be included, and/or any or all of the steps may be performed in a parallel and/or partially overlapping manner without departing from the invention.

In Step 200, a snapshot of data stored in the source device is obtained by the source device. In one or more embodiments, the snapshot of the data may be obtained in response to the source device initiating a data backup process to back up the data to a target device.

In Step 202, access control information associated with the data is retrieved based on the snapshot obtained in Step 200. In one or more embodiments, one or more of the source device agents (e.g., 122, FIG. 1.2) retrieves the access control information of the data based on the snapshot and transmits (in Step 204) the retrieved access control information to the access control device to be stored in an access control file (e.g., 142, FIG. 1.3). In one or more embodiments, in response to initiating the data backup process, the source device may instruct the access control device to create a new access control file for the access control information associated with the data to be backed up.

In Step 206, the data stored in the source device is copied (using one or more source device agents) to the target device to generate a backup of the data in the target device. In one or more embodiments, the copying of the data from the source device to the target device may be done in any way that ensures that all of the data stored in the source device is accurately copied to the target device. For example, the data may be copied using a MapReduce software framework and programming model used for processing large amounts of data.

In one or more embodiments, the source device agents executing Step 204 may be different from the source device agents executing Step 206. For example, the source device agent executing Step 206 may be the above-discussed DISTCP tool for larger inter/intra-cluster copying, while the source device agent executing Step 204 may be separate agent configured only for building the access control file on the access control device, or obtaining the access control information to provide to the access control device for building the access control file. Such a configuration of one or more embodiments advantageously reduces the overhead of each of these source device agents. In particular, having a single source device agent retrieve both the actual data along with the ACLs may be more computing resource demanding and time consuming than having separate agents each take on a single role. Consequently, an overall functionality of the source device during the backup process can also be improved using the above configuration of one or more embodiments.

In Step 208, the access control device transmits the access control file to the target device. In one or more embodiments, once the backup of the data is completed on the target device, one or more of the target device agents (e.g., 162, FIG. 1.4) may instruct the access control device to transmit the access control file to the target device.

In Step 210, once the target device receives the access control file from the access control device, the target device stores the access control file in a metadata directory in the storage (e.g., 164, FIG. 1.4) and associates the access control file with the backup of the data generated in Step 206.

FIG. 2.2 shows a flowchart of a method in accordance with one or more embodiments of the invention. The method depicted in FIG. 2.2 may be performed to preserve data during an incremental backup of a source device in accordance with one or more embodiments of the invention. The method shown in FIG. 2.2 may be performed by, for example, a combination of the source device (e.g., 101, FIG. 1.1; 120, FIG. 1.2), the access control device (e.g., 105, FIG. 1.1; 140, FIG. 1.3), and the target device (e.g., 103, FIG. 1.1; 160, FIG. 1.4).

While FIG. 2.2 is illustrated as a series of steps, any of the steps may be omitted, performed in a different order, additional steps may be included, and/or any or all of the steps may be performed in a parallel and/or partially overlapping manner without departing from the invention.

In Step 220, retrieval of the access control file associated with data stored in a source device is initiated. In one or more embodiments, the retrieval is conducted by the access control device in response to receiving a notification from the source device that an incremental backup of the data is to be executed. An incremental backup of the data occurs when changes to the data stored in the source device are implemented after a backup of the data stored in the source device has already been generated in the target device. Said another way, the incremental backup may be used to backup only changes that have been implemented to the data stored in the source device after the data stored in the source device has already been previously backed up.

In Step 222, a snapshot difference report is obtained using a first snapshot of the data stored in the source device and a second snapshot of the data stored in the source device. In one or more embodiments, the first snapshot may be obtained during a previous full backup of the data (e.g., in Step 200 of FIG. 2.1). Alternatively, the first snapshot as the second snapshot of a previous incremental backup of the data. The second snapshot is obtained in response to the source device initiating the incremental backup. Consequently, the second snapshot is taken at a later time compared to a timing of the first snapshot.

In one or more embodiments, as discussed above in reference to FIG. 1.2, the snapshot difference report includes all changes to the data during the time between first snapshot and the second snapshot. This includes all changes to the access control information associated with the data. For example, after the first snapshot and before the second snapshot, an owner of the data may have added, deleted, or modified one or more portions of the access control information. More specifically, a new file including its own ACL may have been added to the data between the first snapshot and the second snapshot.

In one or more embodiments, the source device generates three lists using the snapshot difference report including, but is not limited to: (i) a first list specifying all deleted files and/or directories; (ii) a second list specifying all renamed files and/or directories; and (iii) a third list specifying all newly created file and/or directories and all files and/or directories whose content have been modified. In one or more embodiments, similar lists may also be generated for the access control information associated with each file and/or directory making up the data.

In Step 224, the access control file obtained in Step 220 is updated using the snapshot difference report to obtain an updated access control file. In one or more embodiments, the access control file is updated using the three lists generated by the source device using the snapshot difference report. By way of example, all entries in the access control file corresponding to the deleted files and/or directories specified in the first list are first deleted. Subsequently, all entries in the access control file corresponding to the renamed files and/or directories are modified to reflect the new names of each file and/or directory in the key portion (i.e., the portion that stored the path of the file and/or directory) of the key-value pair. Further, all value portions (i.e., the portion storing the access information) of the key-value pair entries in the access control file corresponding to the modified access control information are replaced with the modified version of the access control information. Finally, all newly created access control information are stored into the access control file as new entries.

In Step 226, the existing backup of the data stored in the target device is updated using the snapshot difference report to obtain an updated backup in the target device. In one or more embodiments, the updating of the backup may be executed by one or more of the target device agents (e.g., 162, FIG. 1.4) of the target device upon receiving instructions from the source device. The instructions from the source device may be provided based on the above lists generated using the snapshot difference report. For example, similar to the updating of the access control file, the first list specifying all deleted files and/or directories is first processed (i.e., all files and/or directories corresponding to the entries in the first list are deleted from the backup). Subsequently, a second list specifying the remaining information is processed to update the names of the files and/or directories in the backup. Finally, the third list specifying the newly created and modified files and/or directories is processed to: (1) add the newly created files and/or directories to the backup; and (2) replace existing files and/or directories corresponding to the modified files and/or directories with the modified files and/or directories.

In one or more embodiments, although a specific sequence is provided above for updating the access control file and the backup of the data, one of ordinary skill in the art would appreciate that each sub-step in above Steps 224 and 226 may be performed in any sequence as long as the access control file and the backup data are accurately updated to reflect the information in the snapshot difference report.

In Step 228, the access control device transmits the updated access control file to the target device. In one or more embodiments, once the updated backup of the data is completed on the target device, one or more of the target device agents may instruct the access control device to transmit the updated access control file to the target device.

In Step 230, once the target device receives the updated access control file from the access control device, the target device stores the updated access control file back into the metadata directory in the storage (e.g., 164, FIG. 1.4) and associates the updated access control file with the updated backup of the data generated in Step 226.

FIG. 2.3 shows a flowchart of a method in accordance with one or more embodiments of the invention. The method depicted in FIG. 2.3 may be performed to preserve data during a full backup of a source device in accordance with one or more embodiments of the invention. The method shown in FIG. 2.3 may be performed by, for example, a combination of the source device (e.g., 101, FIG. 1.1; 120, FIG. 1.2), the access control device (e.g., 105, FIG. 1.1; 140, FIG. 1.3), and the target device (e.g., 103, FIG. 1.1; 160, FIG. 1.4).

While FIG. 2.3 is illustrated as a series of steps, any of the steps may be omitted, performed in a different order, additional steps may be included, and/or any or all of the steps may be performed in a parallel and/or partially overlapping manner without departing from the invention.

In Step 250, retrieval of an access control file associated with a backup in the target device to be used for restoring and/or recovering data in a source device is initiated. In one or more embodiments, the retrieval is conducted by the access control device in response to receiving a notification from the source device that restoration and/or recovery of the data stored in the source device is to be executed.

In Step 252, in parallel with or subsequently after initiating the retrieval of the access control file, the source device initiates a restoration and/or recovery of the data by retrieving the backup from the target device. In one or more embodiments, the source device copies the backup data stored in the target device and stores these copies back into the storage (e.g., 124, FIG. 1.2) of the source device as recovered data.

In Step 254, once the recovered data is completed in the source device, the source device (using one or more of the source device agents) accesses the access control file stored in the access control device and retrieves the access control information stored in the access control file. The retrieved access control information is assigned to the recovered data using the information included in each key-value pair entry of the access control file.

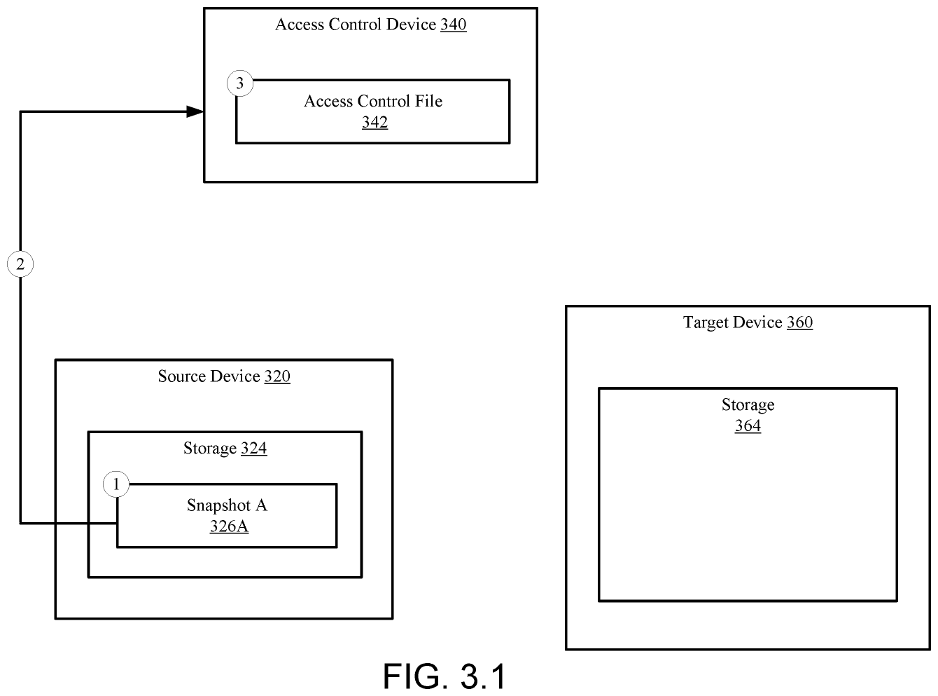

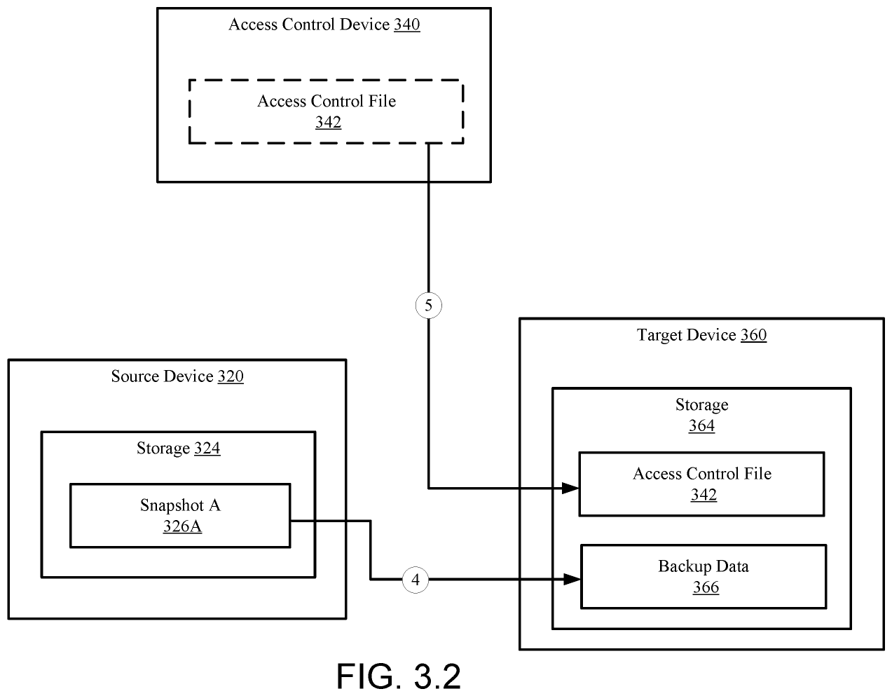

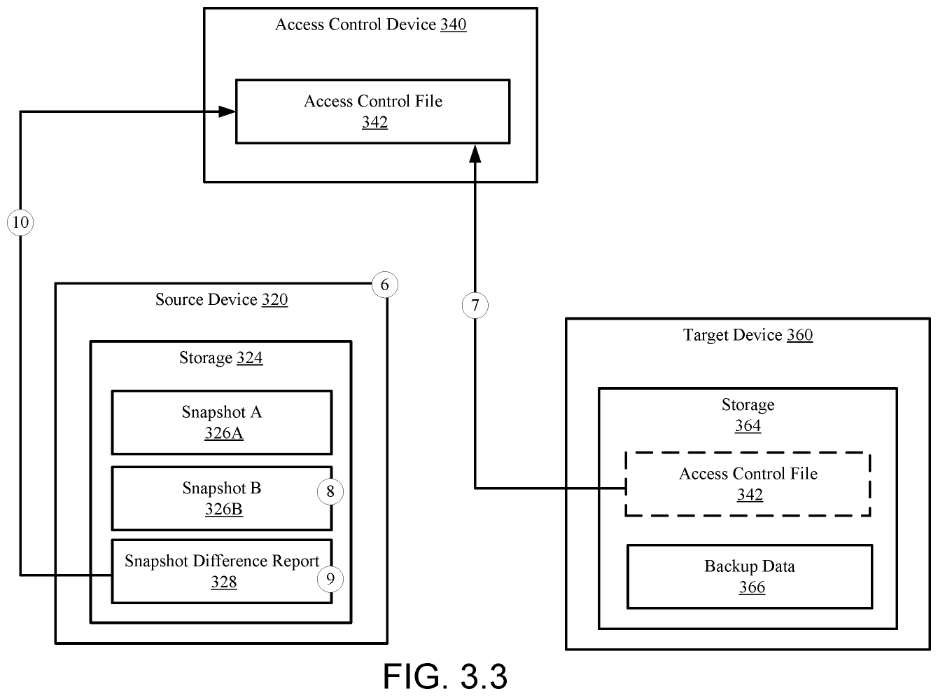

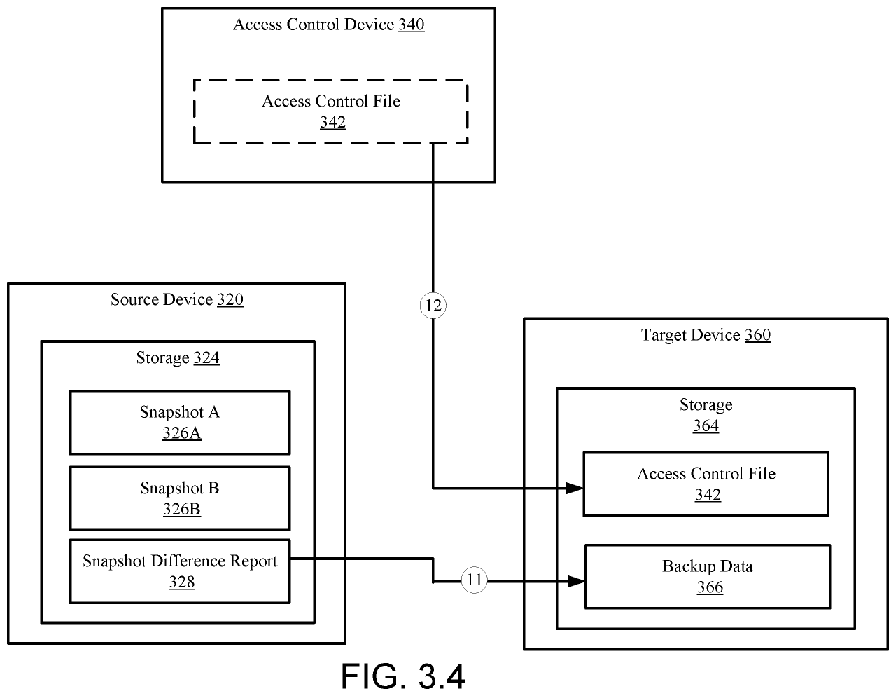

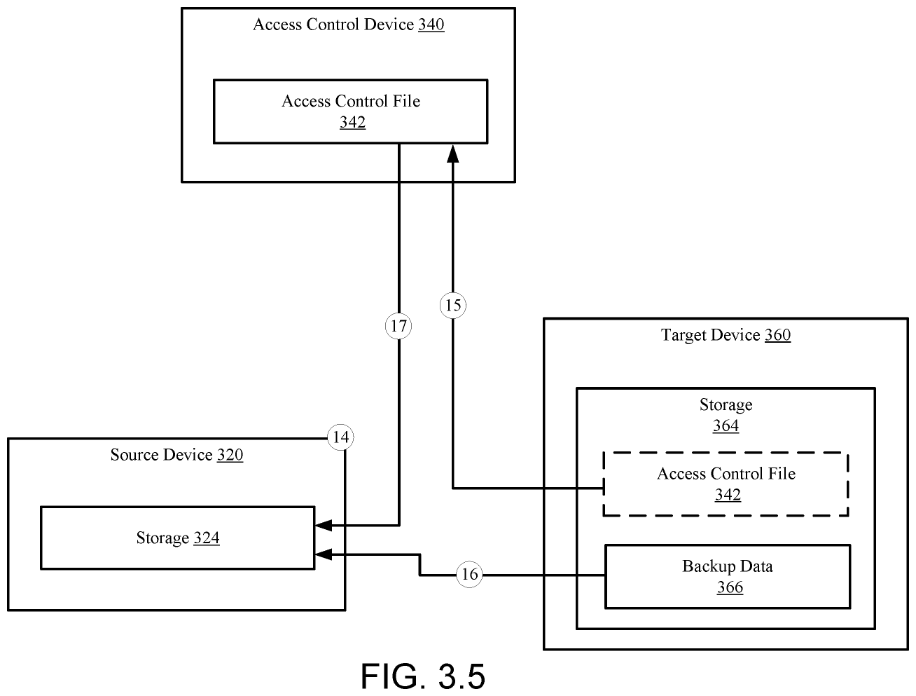

To further clarify embodiments of the invention, a non-limiting example is provided in FIGS. 3.1-3.5.

Beginning of Example

As shown in FIG. 3.1, the source device (320) (e.g., 101, FIG. 1.1; 120, FIG. 1.2) initiates a full backup process and obtains a snapshot A (326A) of data stored in storage (324) (e.g., 124, FIG. 1.2) [1]. The source device parses snapshot A (326A) for access control information associated with the data and transmits the access control information to an access control device (340) (e.g., 105, FIG. 1.1; 140, FIG. 1.3) [2]. The access control device (340) receives the access control information and stores the access control information in an access control file (342) created specifically for the data stored in the source device that is being backed up [3].

Turning now to FIG. 3.2, the source device copies the data using snapshot A and transmits the copies to a target device (360) (e.g., 103, FIG. 1.1; 160, FIG. 1.4) to generate a backup data (366) (i.e., a backup of the data stored in the source device) in the storage (364) of the target device [4]. Upon completion of the generation of the backup data (366) the access control device (340) is notified and transmits the access control file (342) to the target device (360) such that the access control file (342) can be associated with (e.g., stored together with) the backup data (366) [5]. At this point, the full backup process is completed.

After some time has passed since the completion of the full backup, as shown in FIG. 3.3, the source device starts an incremental backup process [6]. In response to the source device starting the incremental backup process, the access control file (342) is retrieved by the access control device (340) from the target device (360) [7]. The source device subsequently obtains a snapshot B (326B) that was taken some time after snapshot A (326A) [8]. A snapshot difference report (328) is then generated using snapshot A (326A) and snapshot B (326B) [9]. In response to generating the snapshot difference report (328), the source device (320) updates the access control file (342) in the access control device (340) using the information from the snapshot difference report (328) [10].

Subsequently or in parallel with updating the access control, as shown in FIG. 3.4, the source device (320) and the target device (360) collectively updates the backup data (366) using the snapshot difference report (328) to reflect any incremental changes that may have been implemented to the data in the source device (320) between the generation of snapshot A (326A) and snapshot B (326B) [11]. Once the backup data is updated, the access control device (340) transmits the updated access control file (342) back to the target device (360) to be stored with the updated backup data [12]. At this point, the incremental backup process is completed.

Turning now to FIG. 3.5, after some time has passed since the completion of either the full backup or the incremental backup, as shown in FIG. 3.5, the source device (320) initiates a data restoration and/or recovery process [14]. In response, the access control device (340) retrieves the access control file (342) from the target device (360) [15]. Subsequently or in parallel with the access control device (340) retrieving the access control file, the source device (320) retrieves the backup data (366) from the target device to restore and/or recover the previous data stored in the storage (324) [16]. Upon completion of the restoration and/or recovery, the source device (320) retrieves the access control information from the access control file (342) and assigns the access control information back to the recovered data [17].

End of Example

FIG. 4 shows a computer system in accordance to one or more embodiments.

Embodiments disclosed herein may be implemented using computing devices. FIG. 4 shows a diagram of a computing device in accordance with one or more embodiments disclosed herein. Computing device (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), communication interface (412) (e.g., Bluetooth interface, infrared interface, network interface, optical interface, etc.), input devices (410), output devices (408), and numerous other elements (not shown) and functionalities. Each of these components is described below.

In one embodiment disclosed herein, computer processor(s) (402) may be an integrated circuit for processing instructions. For example, the computer processor(s) may be one or more cores or micro-cores of a processor. Computing device (400) may also include one or more input devices (410), such as a touchscreen, keyboard, mouse, microphone, touchpad, electronic pen, or any other type of input device. Further, communication interface (412) may include an integrated circuit for connecting computing device (400) to a network (not shown) (e.g., a local area network (LAN), a wide area network (WAN) such as the Internet, mobile network, or any other type of network) and/or to another device, such as another computing device.

In one embodiment disclosed herein, computing device (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to computer processor(s) (402), non-persistent storage (404), and persistent storage (406). Many different types of computing devices exist, and the aforementioned input and output device(s) may take other forms.

The advantages discussed above throughout the detailed description should be understood as being examples associated with one or more problems being solved by embodiments of the invention. However, one or more embodiments of the invention disclosed herein should not be limited to solving the same/similar problems. The disclosed invention is broadly applicable to address a range of problems beyond those discussed herein.

While embodiments described herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A method for preserving data stored in a source device, the method comprising:
obtaining a first snapshot of the data;
retrieving, based on the first snapshot, access control information associated with the data;
storing, in response to the retrieving and in an access control device separate from the source device, the access control information as an access control file;
copying, after the storing and using the first snapshot, the data to a target device to generate a backup of the data in the target device; and
transmitting, after the copying, the access control file to the target device and storing the access control file with the backup.

2. The method of claim 1, wherein the access control information is stored in the access control file as a key-value pair where a key of the key-value pair is a path of the data in the source device and a value of the key-value pair is the access control information.

3. The method of claim 1, further comprising:
retrieving, after storing the access control file with the backup, the access control file to the access control device;
obtaining a second snapshot of the data in the source device, wherein the second snapshot is taken after the first snapshot;
generating a snapshot difference report by comparing the second snapshot to the first snapshot;
updating, using the snapshot difference report, the access control file to obtain an updated access control file;
updating, after updating the access control file and using the snapshot difference report, the backup in the target device to obtain an updated backup; and
transmitting, after updating the backup, the updated access control file to the target device and storing the updated access control file with the updated backup.

4. The method of claim 3, wherein
the snapshot difference report comprises a change to the data between the first snapshot and the second snapshot, and
the data comprises files.

5. The method of claim 4, wherein
the change to the data is a deletion of a file among the files,
the file is associated with a first access control information among the access control information making up the access control file, and
updating the access control file comprises deleting an entry in the access control file associated with the first access control information.

6. The method of claim 4, wherein
the change to the data is a renaming of a file among the files,
the file is associated with a first access control information among the access control information making up the access control file, and
updating the access control file comprises renaming a portion of an entry in the access control file associated with the first access control information to reflect the renaming of the file.

7. The method of claim 4, wherein
the change to the data comprises an addition of a new file to the files,
the new file is associated with a new access control information not included in the access control information retrieved from the first snapshot, and
updating the access control file comprises creating a new entry in the access control file for the new access control information.

8. The method of claim 4, wherein
the change to the data is a modification to a first access control information, among the access control information making up the access control file, to obtain a first modified control information, and
updating the access control file comprises replacing an entry in the access control file corresponding with the first access control information with the first modified access control information to reflect the modification.

9. The method of claim 1, further comprising:
retrieving, after storing the access control file with the backup, the access control file to the access control device;
restoring, in response to retrieving the access control file, the source device by copying the backup associated with the access control file from the target device back to the source device to obtain recovered data in the source device; and
assigning, after restoring the source device and using the access control file, the access control information to the recovered data.

10. The method of claim 1, wherein the access control file comprises a SQLite database.

11. A non-transitory computer readable medium (CRM) storing instructions that, when executed by a computer, cause the computer to execute a method for preserving data in a source device the method comprising:
obtaining a first snapshot of the data;
retrieving, based on the first snapshot, access control information associated with the data;
storing, in response to the retrieving and in an access control device separate from the source device, the access control information as an access control file; and
copying, after the storing and using the first snapshot, the data to a target device to generate a backup of the data in the target device,
wherein after the copying, the access control file is transmitted by the access control device to the target device and stored with the backup.

12. The CRM of claim 11, wherein the access control information is stored in the access control file as a key-value pair where a key of the key-value pair is a path of the data in the source device and a value of the key-value pair is the access control information.

13. The CRM of claim 1, wherein, after the access control file is stored with the backup, the method further comprises:
obtaining a second snapshot of the data in the source device, wherein the second snapshot is taken after the first snapshot;
generating a snapshot difference report by comparing the second snapshot to the first snapshot;
updating, using the snapshot difference report, the access control file to obtain an updated access control file, wherein the access control file is retrieved from the target device by the access control device prior to the obtaining of the second snapshot; and
updating, after updating the access control file and using the snapshot difference report, the backup in the target device to obtain an updated backup,
wherein, after updating the backup, the updated access control file is transmitted by the access control device to the target device and stored with the updated backup.

14. The CRM of claim 13, wherein
the snapshot difference report comprises a change to the data between the first snapshot and the second snapshot, and
the data comprises files.

15. The CRM of claim 13, wherein, after the access control file is stored with the backup, the method further comprises:
initiating a restoration of the source device that causes the access control device to retrieve the access control file from the target database;
restoring, in response to the access control device retrieving the access control file from the target database, the source device by copying the backup associated with the access control file from the target device back to the source device to generate recovered data in the source device; and
assigning, after restoring the source device and using the access control file in the access control device, the access control information to the recovered data.

16. A source device comprising:
a storage storing data; and
a processor coupled to the storage, wherein the processor is configured to:
obtain a first snapshot of the data;
retrieve, based on the first snapshot, access control information associated with the data;
store, in response to the retrieving and in an access control device separate from the source device, the access control information as an access control file; and
copy, after the storing and using the first snapshot, the data to a target device to generate a backup of the data in the target device,
wherein after the copying, the access control file is transmitted by the access control device to the target device and stored with the backup.

17. The source device of claim 16, wherein the access control information is stored in the access control file as a key-value pair where a key of the key-value pair is a path of the data in the source device and a value of the key-value pair is the access control information.

18. The source device of claim 16, wherein, after the access control file is stored with the backup, the processor is further configured to:
obtain a second snapshot of the data in the source device, wherein the second snapshot is taken after the first snapshot;
generate a snapshot difference report by comparing the second snapshot to the first snapshot;
update, using the snapshot difference report, the access control file to obtain an updated access control file, wherein the access control file is retrieved from the target device by the access control device prior to the obtaining of the second snapshot; and
update, after updating the access control file and using the snapshot difference report, the backup in the target device to obtain an updated backup,
wherein, after updating the backup, the updated access control file is transmitted by the access control device to the target device and stored with the updated backup.

19. The source device of claim 18, wherein
the snapshot difference report comprises a change to the data between the first snapshot and the second snapshot, and
the data comprises files.

20. The source device of claim 19, wherein after the access control file is stored with the backup, the processor is further configured to:
initiate a restoration of the source device that causes the access control device to retrieve the access control file from the target database;
restore, in response to the access control device retrieving the access control file from the target database, the source device by copying the backup associated with the access control file from the target device back to the source device to generate recovered data in the source device; and
assign, after restoring the source device and using the access control file in the access control device, the access control information to the recovered data.
